(19) United States
(12) Patent Application Publication
(10) Pub. No.: US 2025/0356543 A1
(43) Pub. Date: Nov. 20, 2025

(54) DATA PROCESSING APPARATUS AND METHOD

(71) Applicant: Sony Interactive Entertainment Inc., Tokyo (JP)

(72) Inventors: Patrick John Connor, London (GB); Jun Yen Leung, London (GB); Maurizio Cerrato, London (GB); Lawrence Green, London (GB); Maria Chiara Monti, London (GB); Rajeev Gupta, London (GB)

(73) Assignee: Sony Interactive Entertainment Inc., Tokyo (JP)

(21) Appl. No.: 19/205,147

(22) Filed: May 12, 2025

(30) Foreign Application Priority Data
May 15, 2024 (GB) 2406867.8

(51) Int. Cl. G06T 11/00; A63F 13/52; G06T 3/4046; G06T 5/60

(52) U.S. Cl. CPC G06T 11/001; A63F 13/52; G06T 3/4046; G06T 5/60; G06T 2207/20081; G06T 2207/20084; G06T 2210/36

(57) ABSTRACT

A data processing apparatus comprising circuitry configured to: obtain a first version of a texture having a first quality level; generate, using the first version of the texture, a prediction of a second version of the texture having a second quality level, the second quality level being higher in quality than the first quality level; and output, for display, the prediction of the second version of the texture.

### BACKGROUND

### Field of the Disclosure

This disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly nor impliedly admitted as prior art against the present disclosure.

In computer graphics, such as those used for video games, a method known as texture streaming may be used to help ensure good visual quality is balanced against memory usage. It achieves this by the use of level-of-detail (LoD) in textures, often described as “mipmaps” or “mips”. A full mip chain of the texture normally consists of the highest resolution version of the texture, and then one or more versions of the texture that are reduced in data size (and therefore resolution and/or quality). Each different version of the texture in the mip chain may be referred to as a “mip” and corresponds to a different level of the mip chain.

In a typical video game, not all textures require the highest level of detail at all times. Thus, when an asset (e.g. a virtual in-game object) is loaded by a game and the textures it requires are identified, these textures, together with their respective mip levels, are put on a request list of the texture streamer. Each request on the request list is thus defined by an identifier of a particular texture and a mip level of that texture.

The texture streamer causes the transfer of the textures on the request list from storage media to main memory (e.g. memory accessible to a graphics process unit, GPU). The requests are prioritised on the request list so higher priority textures are transferred before lower priority textures. For example, textures may be prioritised by the post-rasterized size (e.g. in number of pixels) of the texture on the screen (with larger post-rasterized sizes having a higher priority than smaller post-rasterized sizes). Other parameter(s) may also be used for prioritisation, such as textures associated with main character(s) in the video game being given higher priority than those of background character(s), for example.

A problem with texture streaming, however, is that there will often be a delay between a request for a higher quality mip of a texture being added to the request list and this higher quality mip actually being transferred from the storage media to the main memory. Similarly, if the texture has a lower priority than that of another, a lower quality mip of the texture may be loaded initially or the delay to it being loaded may be longer (since it is not loaded until the higher priority texture has been loaded first). Latency in obtaining higher quality texture mips is therefore increased.

To mitigate this issue, an existing solution is for texture streamers to progressively load higher quality mips over time. That is, all textures on the request list are initially obtained at the lowest quality mip level to allow all textures to be obtained with reduced latency. These are then replaced, as necessary, with higher quality mip levels (i.e. those indicated in the request for each texture in the request list) over time. However, this can lead to so-called texture “popping” where the user notices higher quality textures appear from one frame to the next. This is undesirable since it detracts from the realism of the game graphics and, hence, the immersion of the user in the game.

There is therefore a desire to alleviate these problems.

### SUMMARY

The present technology is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIGS. 2A and 2B schematically show example components associated with the entertainment system;

FIG. 3 schematically shows an example of prediction processing;

FIG. 4 schematically show an example of prediction processing in more detail;

FIG. 5 schematically shows an example of texture atlas generation;

FIG. 6 shows a first example method; and

FIG. 7 shows a second example method.

Like reference numerals designate identical or corresponding parts throughout the drawings.

### DETAILED DESCRIPTION OF THE EMBODIMENTS

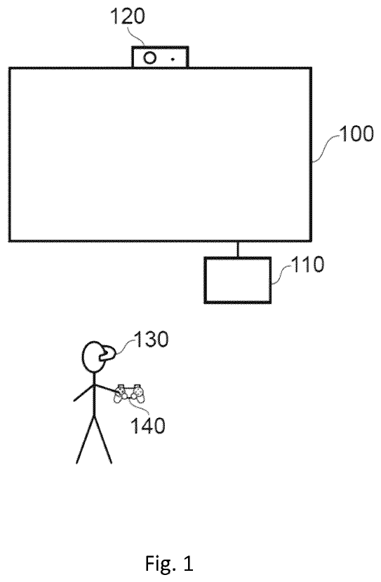

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself—for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

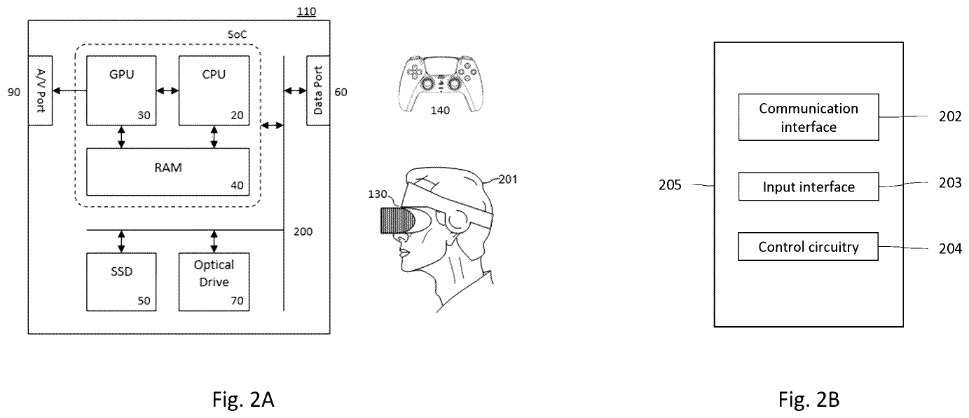

FIG. 2A shows an example of the games console 110. The games console 110 is an example of a data processing apparatus.

The games console 110 comprises a central processing unit or CPU 20. This may be a single or multi core processor, for example comprising eight cores. The games console also comprises a graphical processing unit or GPU 30. The GPU can be physically separate to the CPU, or integrated with the CPU as a system on a chip (SoC).

The games console also comprises random access memory, RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive (SSD), or an internal SSD.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

FIG. 2B shows some example components of a peripheral device 205 for receiving input from a user. The peripheral device comprises a communication interface 202 for transmitting wireless signals to and/or receiving wireless signals from the games console 110 (e.g. via data port(s) 60) and an input interface 203 for receiving input from the user. The communication interface 202 and input interface 203 are controlled by control circuitry 204.

In an example, if the peripheral device 205 is a controller (like controller 140), the input interface 203 comprises buttons, joysticks and/or triggers or the like operable by the user. In another example, if the peripheral device 205 is a microphone, the input interface 203 comprises a transducer for detecting speech uttered by a user as an input. In another example, if the peripheral device 205 is a fitness tracker, the input interface 203 comprises a photoplethysmogram (PPG) sensor for detecting a heart rate of the user as an input. The input interface 203 may take any other suitable form depending on the type of input the peripheral device is configured to detect.

As mentioned above, there is a desire to reduce latency in loading higher quality mips and to reduce the “popping” associated with progressive loading. To achieve this, the present technology allows a higher quality mip of a texture to be predicted from a lower quality mip. The predicted mip is then output until the higher quality mip has been obtained from storage. In an example, mip quality is associated with mip data size. That is, a higher quality mip (that is, a mip with higher resolution, for example) will have a higher data size whereas a lower quality mip (that is, a mip with lower resolution, for example) will have a lower data size.

In an example, the lowest-quality mip for each texture is loaded into memory (e.g. RAM 40) from one or more storage media (e.g. SSD 50, optical drive 70 and/or storage of a remote data processing apparatus (not shown) in communication with the games console 110 via data port 60) when the video game is initialised. This allows the lowest quality mip for each texture to be obtained as needed with very little latency (that is, with latency sufficiently low that it cannot be easily noticed by a user of the video game, e.g. 100 ms or less).

These lowest quality versions of the textures may be comprised within one of a plurality of different texture atlases, with all the textures of one texture atlas being loaded into memory together. Each texture atlas comprises, for example, correlated textures. For example, a “foliage” texture atlas may comprise a set of foliage textures for outdoors sections of the game whereas a “building” texture atlas may comprise a set of building textures for city areas of the game. These atlases may be loaded separately for different sections of the game, meaning not all atlases need to be loaded at all times.

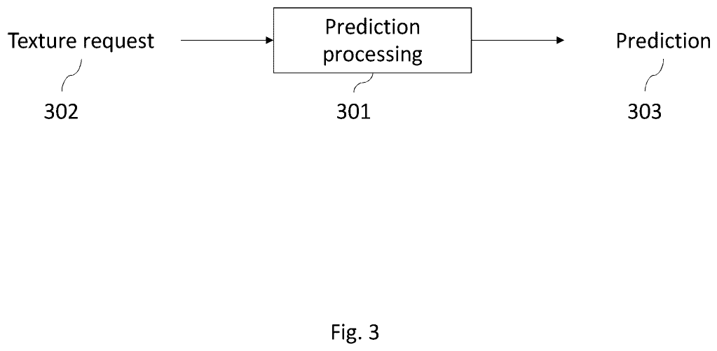

When a particular texture is requested at a higher quality mip level than the lowest quality mip already stored in memory (e.g. as part of a pre-loaded atlas), the lowest quality mip is input to prediction processing to generate a prediction of the higher quality mip which has been requested. This is exemplified in FIG. 3, which shows a texture request 302 from the request list of the texture streamer being input to a prediction processing step 301 (implemented by the CPU 20 and/or GPU 30, for example). The prediction processing step 301 obtains the lowest quality mip of the requested texture already loaded in memory (e.g. RAM 40) and performs prediction processing to upsample the lowest quality mip to obtain a prediction 303 of the texture at the requested higher quality mip.

In an example, the prediction processing 301 is carried out by a suitably trained machine learning model for upsampling images. The model is trained on, for example, the mip chain of each texture in a particular video game (e.g. to minimise an error function between a predicted version of the texture at each mip level and the actual version of the texture at that mip level). The model may be trained on different categories of texture (e.g. “foliage” or “building” textures) so that each category of texture is associated with a different set of trained model parameters (e.g. weights and/or biases when the model is an artificial neural network, ANN). In an example, textures in the same category (that is, the same classification or group) are also in the same texture atlas. Thus, as well as each atlas comprising the lowest quality mip of each texture, the atlas also comprises the model parameters for the prediction processing of those textures.

In an example, the textures are static, two-dimensional textures in UV-space. The model may be, for example, any suitable known model capable of carrying out Super-Resolution (SR) of images. Such models include UNet, HAT-L or the like, for example. UNet, in particular, has a U-shaped process of downsampling an input image before processing then upsampling. If used with the present technique, the downsampling steps of the model are not required, since the full mip chain for the texture already exists and thus lower resolution mips have already been generated. The processing associated with downsampling when this particular model is used is therefore reduced.

By using prediction processing in this way, higher resolution textures can be obtained with low latency (that is, with latency sufficiently low that it cannot be easily noticed by a user of the video game, e.g. 100 ms or less). Furthermore, once the actual texture at the requested mip level has been loaded into memory, the predicted texture can be replaced with the actual texture and, since the resolution has not changed (since the predicted and actual textures have the same resolution), the effect of “popping” is alleviated. In another example, if the predicted texture is of sufficient similarity to the actual texture, no replacement may be necessary. The need to load the higher quality mip of the texture from storage is thus alleviated altogether, thereby saving memory.

As mentioned above, the machine learning model may be trained using different categories of textures (so different model parameters are used for different texture categories) or the entire texture set for a game (so a different respective set of model parameters is used for each texture). Both the categorisation of textures (if present) and the training of the model may be carried out as part of the existing texture mip chain generation process (which involves, for example, generating the same texture at a different resolution for each mip level) for building the texture assets of a video game. The model parameters (e.g. biases and weights) for each texture asset or texture category may then be stored ahead of the mip chain for that asset or category and parsed as the first step in loading that item.

Thus, for example, when each texture asset is associated with its own respective set of model parameters, these may be stored with the higher quality mips and accessed before the higher quality mips. This allows the model parameters to be obtained and applied to the model and for the model to then generate the predicted texture at the requested mip level with low latency. The actual texture at the requested mip level can then be obtained afterwards. On the other hand, if all textures in the same category are associated with the same set of model parameters, these model parameters only need to be obtained once for all textures in that category. If all textures in the same category also belong to the same texture atlas, the model parameters may thus be provided as part of the texture atlas, for example. It will also be appreciated that a single set of parameters may be used for all textures (in which case, there is no need to load different model parameters for different texture assets or categories).

The model parameters which work best for a particular texture may also help determine what the texture categories should be in the first place. In particular, grouping patterns may emerge which a human would not have chosen. For instance, it may be that, based on which of a plurality of sets of model parameters work best for a particular texture, a building texture is better predicted by the parameter set for what a human classifier would have chosen as the “foliage” category rather than the “building” category. Different categories may thus be associated with different respective sets of model parameters and texture assets assigned to a particular category depending on the performance of the ML model for prediction of that texture asset rather than a human classification.

The different categories may thus not correspond with the texture atlases. That is, for instance, two texture assets in the “building” texture atlas may be in different categories. In this case, an identifier of the category of each texture may be provided with the lowest quality mip of that texture in the texture atlas or with the mip chain of that texture in storage. The model parameters of the identified category may then be obtained and applied to the model. If successively requested textures in the request belong to the same category, this means the model parameters only need to be obtained once, thereby reducing processing and further reducing latency. Since the same model parameters are used for all textures in the same category, this also reduces storage requirements since, rather than the same set of model parameters being repeatedly stored with the mip chain of every texture asset in the game, the set of model parameters associated with each category need only be stored once and obtained when that category is identified for a particular texture asset.

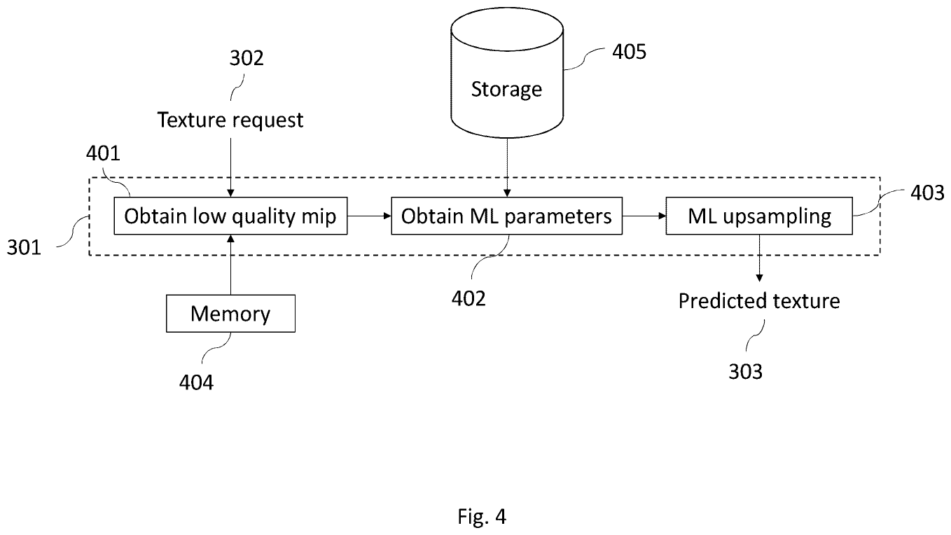

FIG. 4 show exemplifies steps of the prediction processing step 301 in more detail.

At step 401, the lowest quality mip of the texture identified in the texture request 302 is obtained. The lowest quality mip of the texture has been previously stored in memory 404 (e.g. RAM 40) as part of the relevant texture atlas, for example.

At step 402, the machine learning model parameters associated with the texture are obtained. As previously explained, these are, for example, model parameters specifically associated with the texture or specifically associated with the category and/or texture atlas of the texture. In this example, the model parameters are obtained from storage 405 (e.g. SSD 50) since, for example, they are stored with the mip chain of the texture or in association with a category identifier of the texture. However, they may also be included in memory, for example as part of the texture atlas.

At step 403, the obtained model parameters are applied to the machine learning model and the machine learning model upsamples the lowest quality mip to match the quality indicated in the texture request. The resulting upsampled texture is the predicted texture 303 output by the prediction processing 301.

In the example of FIG. 4, the memory 404 is volatile memory in which data can be written and read more quickly than data stored in storage 405. The storage 405 is non-volatile memory.

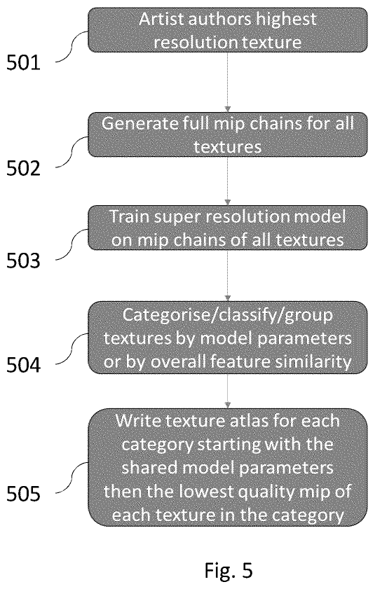

FIG. 5 shows a specific example for generating model parameters for different texture categories.

At step 501, a highest resolution of a texture is authored by an artist.

At step 502, a full mip chain for the texture is generated. The full mip chain comprises a plurality of versions of the texture at different respective resolutions, for example.

At step 503, an ML model is trained to upsample the lowest resolution mip in the mip chain to generate a predicted version of any one of the higher resolution mips in the mip chain (up to and including the resolution of the original texture authored at step 501). As previously explained, the ML model is trained using all textures of the particular video game concerned and the parameters of the ML model be may adjusted depending on the texture, texture category or texture atlas.

In this example, at step 504, each texture is categorised based on the optimal model parameters for that texture or overall feature similarity with other textures.

At step 505, all textures allocated to the same category are allocated to the same texture atlas. The texture atlas contains the lowest quality mip of each texture in the category and the ML model parameters which apply to all textures in the texture atlas.

In an example, ML model parameters are determined for each individual texture and textures with model parameters within a predetermined threshold of each other are determined to be in the same category. That is, for example, two textures are determined to be within the same category if each ML model parameter of one of the textures is within a predetermined threshold (e.g. within 20%) of the corresponding ML model parameter of the other texture. The ML model parameters of the category (and texture atlas, in this case) are then calculated as an average of the ML model parameters of each texture in the category, for example.

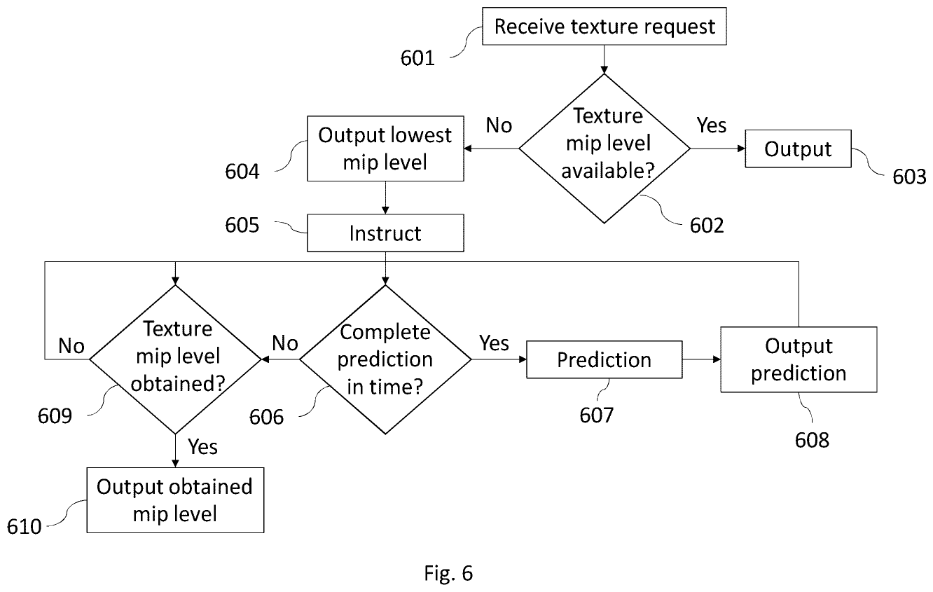

FIG. 6 shows an example method for obtaining and outputting textures during execution of a video game. The method is executed by the CPU 20 and/or GPU 30 of the games console 110, for example.

At step 601, a texture request is received from the texture streamer. The texture request identifies the requested texture and the requested mip level of that texture.

At step 602, it is determined whether the requested mip level is already available in memory 404. If the requested mip level is already available in memory (e.g. if it has already been obtained for a previous frame of the video game), the texture at the requested mip level is output at step 603. If the requested mip level is not already available in memory, the method proceeds to step 604.

At step 604, the lowest quality mip level of the texture (which is already in memory as part of the previously loaded texture atlas, for example) is output for display.

At step 605, an instruction is executed to obtain the texture at the requested mip level from storage 405.

At step 606, it is determined whether a predicted version of the texture at the requested mip level can be generated (via the prediction processing 301) before the actual version of the texture at the requested mip level has been obtained from storage 405. The time duration required to obtain the actual version of the texture at the requested mip level from storage 405 thus corresponds to a threshold time duration within which the prediction processing must be performed. The threshold time duration may, for example, take one of a plurality of predetermined values depending on the data size of the actual texture at the requested mip level which is to obtained (so will be longer for larger data sizes and shorter for smaller data sizes).

If the prediction version of the texture can be generated in time, the predicted texture is generated at step 607 and output for display at step 608. Once generated, the predicted texture at the requested mip level thus replaces the lowest quality mip of the texture in the current video output.

The method then proceeds to step 609. On the other hand, if the predicted version of the texture cannot be generated in time, the method proceeds straight to step 609.

At step 609, it is determined whether the texture at the requested mip level has been successfully obtained from storage 405. If it has not been successfully obtained, step 609 is repeated. On the other hand, if it has been successfully obtained then, at step 610, the obtained texture at the requested mip level is output for display, thus replacing the lowest quality mip of the texture (if the answer at step 606 was “No”) or the predicted version of the texture (if the answer at step 606 was “Yes”) in the current output.

The method of FIG. 6 thus helps alleviate the effects of “popping” by generating and outputting a predicted version of a requested texture at a requested mip level whenever the time required to generate and output this predicted version of the texture can occur is less than the time required to obtain the actual version of the requested texture at the requested mip level from storage. The predicted version of the texture is then replaced with the actual version of the texture once the actual version of the texture has been obtained. This helps provide an increased output texture resolution more quickly, thereby reducing the likelihood of “popping” being perceived by the user. Realism of the video game graphics and hence immersion of the user in the video game is therefore improved.

In an alternative example, if the predicted texture at the higher quality mip level can be generated sufficiently quickly (that is, sufficiently quickly so that any latency in generation of the predicted texture is unlikely to be noticed by the user, e.g. within a predetermined time duration threshold such as 1/16, 1/24, 1/50, 1/60 or 1/90 of a second), there is no need for the lowest quality mip of a texture to be output for display at all. Rather, if the predicted texture can be generated more quickly than the actual texture at the requested quality can be obtained from storage, the predicted texture is generated and output. It is then, optionally, replaced with the actual texture once this has been obtained. The lowest quality mip of the texture is thus displayed only if the predicted texture at the requested quality cannot be generated sufficiently quickly. The output lowest quality mip of the texture is then, optionally, replaced by the predicted and/or actual texture at the higher quality mip once these texture(s) become available.

To further reduce latency, the present technology may be implemented using specific hardware (e.g. to accompany specific hardware for performing existing functions such as decompression of data files in certain compressed storage formats) to run the machine learning model as part of the initial loading of a low resolution texture atlas (e.g. if all textures in the texture atlas use the same set of model parameters) or individual low resolution texture mips (e.g. if different textures or different texture categories use different respective sets of model parameters). This also helps reduce the CPU and/or GPU cost of the present technology (since the texture prediction is carried out using the dedicated hardware rather than CPU and/or GPU resources).

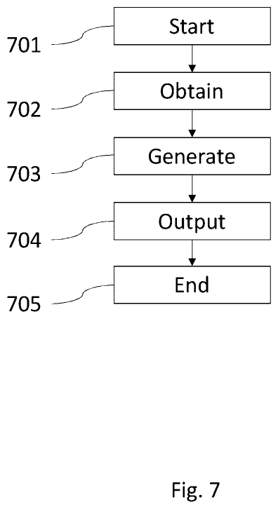

FIG. 7shows an example method. The method is executed by the CPU 20 and/or GPU 30 of the games console 110, for example.

The method starts at step 701.

At step 702, a first version of a texture having a first quality level (e.g. the lowest quality mip of the texture) is obtained.

At step 703, using the first version of the texture, a prediction of a second version of the texture having a second quality level (e.g. the higher quality mip indicated in the texture request) is generated. The second quality level is higher in quality (e.g. higher in resolution) than the first quality level.

At step 704, the prediction of the second version of the texture is output for display.

The method ends at step 705.

Example(s) of the present technique are defined by the following numbered clauses:
1. A data processing apparatus comprising circuitry configured to:
   obtain a first version of a texture having a first quality level;
   generate, using the first version of the texture, a prediction of a second version of the texture having a second quality level, the second quality level being higher in quality than the first quality level; and
   output, for display, the prediction of the second version of the texture.
2. A data processing apparatus according to clause 1, wherein the circuitry is configured to:
   obtain the second version of the texture having the second quality level; and
   output, for display, the second version of the texture in place of the prediction of the second version of the texture.
3. A data processing apparatus according to clause 2, wherein the first version of the texture is obtained from volatile memory and the second version of the texture is obtained from non-volatile memory.
4. A data processing apparatus according to any preceding clause, wherein the circuitry is configured to upsample the first version of the texture to generate the second version of the texture using a trained machine learning model.
5. A data processing apparatus according to clause 4, wherein the machine learning model is trained by minimising an error function between the prediction of the second version of the texture and the second version of the texture.
6. A data processing apparatus according to clause 5, wherein a respective set of parameters of the machine learning model is determined for each of a plurality of textures of a video game.
7. A data processing apparatus according to clause 5, wherein a respective set of parameters of the machine learning model is determined for each of a plurality of categories of texture of a video game.
8. A data processing apparatus according to clause 7, wherein all textures of the video game in a same category correspond to a texture atlas.
9. A data processing apparatus according to clause 8, wherein:
   the texture atlas comprises, for each texture in the category, data representing a first version of the texture having the first quality level and the parameters of the machine learning model; and
   the circuitry is configured to load the texture atlas into volatile memory.
10. A data processing apparatus according to any preceding clause, wherein the circuitry is configured to generate the prediction of the second version of the texture when a required time duration for generating the prediction is less than a threshold time.
11. A data processing apparatus according to any preceding clause, wherein the circuitry is configured to output, as an initial output for display, the first version of the texture.
12. A data processing apparatus according to any preceding clause, wherein the first and second versions of the texture are first and second mipmaps of the texture.
13. A computer-implemented data processing method comprising:
   obtaining a first version of a texture having a first quality level;
   generating, using the first version of the texture, a prediction of a second version of the texture having a second quality level, the second quality level being higher in quality than the first quality level; and
   outputting, for display, the prediction of the second version of the texture.
14. A program for controlling a computer to perform a method according to clause 13.
15. A computer-readable storage medium storing a program according to clause 14.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A data processing apparatus comprising circuitry configured to:
obtain a first version of a texture having a first quality level;
generate, using the first version of the texture, a prediction of a second version of the texture having a second quality level, the second quality level being higher in quality than the first quality level; and
output, for display, the prediction of the second version of the texture.

2. A data processing apparatus according to claim 1, wherein the circuitry is configured to:
obtain the second version of the texture having the second quality level; and
output, for display, the second version of the texture in place of the prediction of the second version of the texture.

3. A data processing apparatus according to claim 2, wherein the first version of the texture is obtained from volatile memory and the second version of the texture is obtained from non-volatile memory.

4. A data processing apparatus according to claim 1, wherein the circuitry is configured to upsample the first version of the texture to generate the second version of the texture using a machine learning model.

5. A data processing apparatus according to claim 4, wherein the machine learning model is trained by minimising an error function between the prediction of the second version of the texture and the second version of the texture.

6. A data processing apparatus according to claim 5, wherein a respective set of parameters of the machine learning model is determined for each of a plurality of textures of a video game.

7. A data processing apparatus according to claim 5, wherein a respective set of parameters of the machine learning model is determined for each of a plurality of categories of texture of a video game.

8. A data processing apparatus according to claim 7, wherein all textures of the video game in a same category correspond to a texture atlas.

9. A data processing apparatus according to claim 8, wherein:
the texture atlas comprises, for each texture in the category, data representing a first version of the texture having the first quality level and the parameters of the machine learning model; and
the circuitry is configured to load the texture atlas into volatile memory.

10. A data processing apparatus according to claim 1, wherein the circuitry is configured to generate the prediction of the second version of the texture when a required time duration for generating the prediction is less than a threshold time.

11. A data processing apparatus according claim 1, wherein the circuitry is configured to output, as an initial output for display, the first version of the texture.

12. A data processing apparatus according to claim 1, wherein the first and second versions of the texture are first and second mipmaps of the texture.

13. A computer-implemented data processing method comprising:
obtaining a first version of a texture having a first quality level;
generating, using the first version of the texture, a prediction of a second version of the texture having a second quality level, the second quality level being higher in quality than the first quality level; and
outputting, for display, the prediction of the second version of the texture.

14. A non-transitory computer-readable storage medium storing a program for controlling a computer to perform a data processing method comprising:
obtaining a first version of a texture having a first quality level;
generating, using the first version of the texture, a prediction of a second version of the texture having a second quality level, the second quality level being higher in quality than the first quality level; and
outputting, for display, the prediction of the second version of the texture.
